(19) United States
(12) Patent Application Publication
(10) Pub. No.: US 2003/0121965 A1
(43) Pub. Date: Jul. 3, 2003

(54) Ring mounted calculator

(75) Inventor: Harold Shevers JR., Cincinnati, OH (US)

Correspondence Address: WOOD, HERRON & EVANS, LLP, 2700 CAREW TOWER, 441 VINE STREET, CINCINNATI, OH, 45202, US

(73) Assignee: Sportsman's Market, Inc., Batavia, OH (US)

(21) Appl. No.: 10/039,370

(22) Filed: Jan. 2, 2002

(51) Int. Cl. G06F 1/00

(52) U.S. Cl. 235/61 R

(57) ABSTRACT

A ring mounted calculator includes a housing with apertures disposed on adjacent side edges for removably attaching the computer assembly in a variety of ring binders having varied ring configurations and dispositions.

### FIELD OF THE INVENTION

This invention relates to calculators for performing calculations, and more particularly to a calculator which may be removably attached in a ring binder.

### BACKGROUND OF THE INVENTION

Calculators and small computers are convenient for performing calculations and other tasks. For example, aircraft pilots often use dedicated flight calculators known as electronic E6B computers to perform calculations necessary for flight planning and navigation. Such calculators are often used with reference to charts, maps, flight planning, aircraft performance and other information. Therefore it is often convenient to store and carry these calculators in those notebooks or binders having openable rings securing the charts and maps, for example, typically carried by a pilot.

Prior computers of more general application have been provided with means for attaching the computer to the rings of such a binder. Such prior computers are generally provided with mounting holes along a side edge of the computer wherein the mounting holes are spaced to fit a given style binder.

One drawback of these prior general computers is that they cannot be readily attached in a binder which has a ring arrangement that is different from the hole pattern provided on the computer. This is a problem when users must frequently work with a variety of binder formats and therefore have a need to periodically attach the computer in a variety of binders having different ring configurations. For example, in the aviation field, pilots utilize various charts for navigational purposes. The charts are generally provided in different formats, depending primarily on the source. National Aeronautical Charting Offices (NACO) Terminal Procedure charts are provided in a format having four binder ring holes along the top edge. These are secured in a ring binder having four rings along a top edge, known generally as an “FAA” style binder. Alternatively, Jeppesen Sanderson® produces instrument procedure charts in a different format, with seven binder ring holes on the chart side edges. A Jeppesen® binder with seven binder rings along a side spine is useful for securing these charts. “Jeppesen” and “Jeppesen Sanderson” are registered trademarks of Jeppesen Sanderson, Inc., Englewood, Colo. Alternatively, maps and charts may be provided in a standard three-ring binder having three rings along a vertical spine.

Regardless of the type of charts used by a pilot, an E6B calculator is desirable to have on hand. Yet, there is no known E6B calculator which can be efficiently mounted in and carried by both an FAA style binder and a Jeppesen® style binder. Thus, if a pilot changes his style of charts, his current E6B calculator may not fit in his new binder. Moreover, a supply outlet must carry a stock of calculators in different configurations to fit each of the binder styles.

There is thus a need for mounting an aviation style E6B calculator to a variety of ring binder formats.

### SUMMARY OF THE INVENTION

The present invention contemplates mounting a calculator with equal facility to a variety of ring binder formats. The calculator is fixedly attached to, or is part of, a housing which protects the calculator and provides a variable attachment to the openable rings of a ring binder. The housing further includes a first side edge and a second side or top edge adjacent and perpendicular to the first side edge. Binder ring holes are provided in the first and second edges. The hole orientation along the top edge varies from that along the first side edge for attachment of the housing to various styles of ring binders. Accordingly, the calculator of the present invention may be removably attached to the rings of a ring binder whether the rings are disposed along its top edge or its side edge. In particular, the calculator may be attached to a ring binder having four rings along a top edge of the binder, or it may be attached to a ring binder having seven rings arranged along a side spine of the binder. Alternatively, the calculator may be attached to a standard three-ring binder along its side edge.

The calculator typically has a keypad, for entering data and instructing the calculator to perform particular aviation functions. It also has a display device which may indicate the user's input directions and display the desired output. In an exemplary embodiment, the calculator of the present invention is adapted for aviation, although the invention may have applications in other fields as well.

These and other features, advantages and objectives of the invention will become more readily apparent to those of ordinary skill in the art upon review of the following detailed description of the preferred embodiments taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a plan view of an exemplary embodiment of a calculator according to the principles of the present invention;

FIG. 2 is a perspective view of the calculator of FIG. 1 installed in one style of ring binder;

FIG. 3 is a perspective view of the calculator of FIG. 1 attached to another style of ring binder; and

FIG. 4 is a perspective view of the calculator of FIG. 1 installed in a standard three-ring binder.

### DETAILED DESCRIPTION

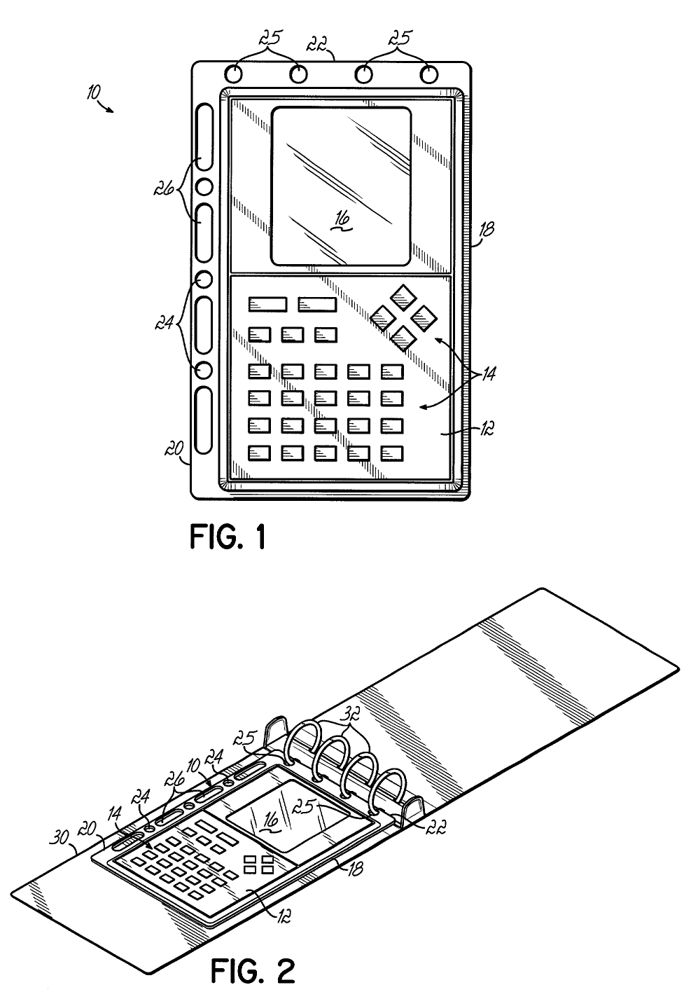

FIG. 1 depicts an exemplary calculator assembly 10 of the present invention. The calculator assembly 10 includes a calculator 12 preferably having a keyboard input device 14 for inputting data and directing the calculator to perform particular functions. The calculator 12 also preferably includes a display device 16, such as a liquid crystal display (LCD) or other viewable display, for indicating user-directed input and providing appropriate output.

The assembly 10 further includes a housing 18 which encases and protects the calculator 12. The housing 18 includes a first side 20 edge and a second side or top edge 22 adjacent and perpendicular to the first side edge 20. The first side edge 20 is provided with hole-shaped apertures 24 and elongated apertures 26, sized and arranged to receive the rings of various side-ring binder configurations. The second side or top edge 22 defines a plurality of hole shaped apertures 25 which could be in the form of elongated slots, if desired.

The housing 18 may be manufactured separately and assembled to a calculator 12. Alternately, the housing 18 may be an integral part of the calculator 12.

Referring to FIG. 2, the exemplary calculator assembly 10 of the present invention is shown attached to a ring binder 30 having four openable top rings 32 disposed along a top spine of the binder 30. One such binder is used for securing aircraft flight charts and is often referred to as a “FAA” style ring binder. The calculator assembly 10 is attached to the openable rings 32 through the apertures 25 located on the second side, or top, edge 22 of the housing 18. Advantageously, the calculator assembly 10 may be relatively thin and lightweight whereby it may be attached in the binder 30 along with other papers such as charts, maps, and various other information.

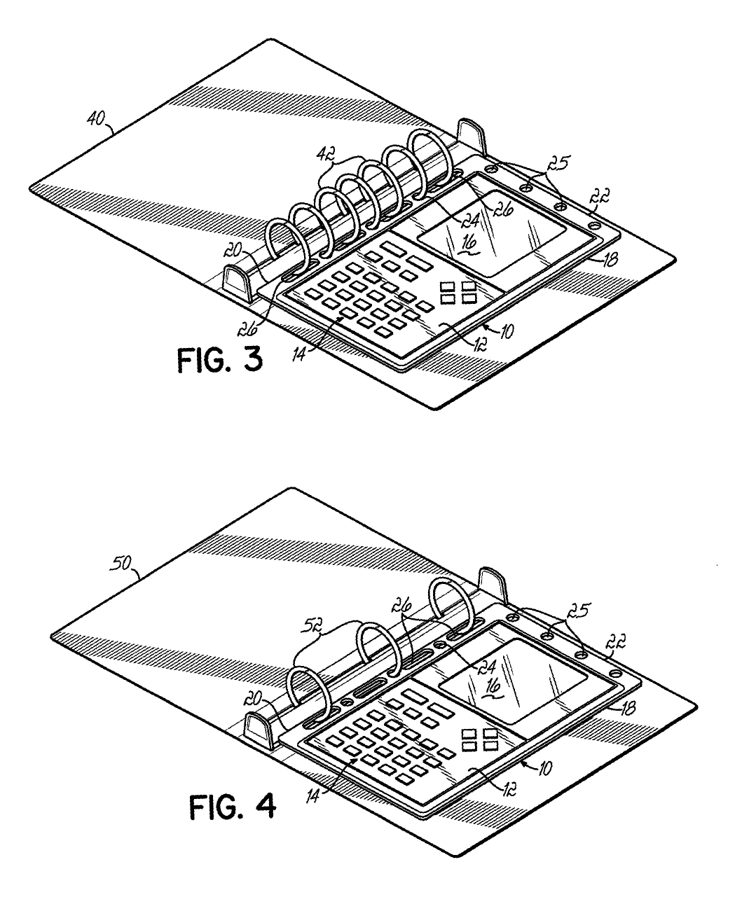

Referring to FIG. 3, the exemplary calculator assembly 10 of the present invention is shown in an alternate binder 40 having seven openable rings 42 disposed along a side spine within the binder 40. One such binder is known as a Jeppesen® binder. As shown in FIG. 3, the calculator assembly 10 is attached to the openable rings 42 of the binder 40 through the apertures 24, 26 located along the first side edge 20 of the housing 18.

Referring to FIG. 4, the calculator assembly 10 of the present invention is shown attached to a standard three-ring binder 50, having three rings 52 spaced along a vertical spine of the binder 50. In this installation, the calculator assembly 10 is attached to the openable rings 52 of the binder 50 through various ones of the apertures 24, 26 in the first side edge 20 of the housing 18.

The construction of the calculator and housing of the present invention is such that the calculator assembly may be easily attached to and removed from binders and notebooks having various ring configurations. Advantageously, the calculator of the present invention may be used by individuals, such as pilots, who have a need or desire to removably attach the computer in binders of varying ring arrangements. Moreover, an aviation supply source need stock only one form of binder mountable E6B calculator, which is as easily mounted in an FAA top ring chart binder or a Jeppesen® side ring chart binder. Inventory can thereby be reduced.

While the present invention has been illustrated by the description of various embodiments thereof, and while the embodiments have been described in considerable detail, it is not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of applicant's general inventive concept.

What is claimed is:

1. A ring mountable calculator which may be removably attached in a ring binder, the calculator comprising:
a housing having a first edge, and a second edge adjacent said first edge;
a calculator disposed in the housing;
one set of apertures disposed in one configuration on said first edge; and
another set of apertures disposed in another configuration on said second edge.

2. The calculator of claim 1 wherein said one set of apertures is sized and spaced to fit a first ring binder having four rings proximate one corresponding edge of the binder, and said another set of apertures is sized and spaced to fit rings of a second ring binder with rings disposed proximate another corresponding adjacent edge of the second binder.

3. The calculator of claim 2 wherein said first ring binder is an FAA chart binder and wherein said second ring binder is a Jeppeseng chart binder.

4. The calculator of claim 2 wherein said second ring binder is one of a Jeppesen® chart binder and a three-ring binder.

5. The calculator of claim 1 wherein said other set of said apertures comprises hole-shaped apertures and slot-shaped apertures for attachment of a calculator to at least two binders having rings oriented in different configurations relative to each other.

6. The calculator of claim 1 wherein said calculator and said housing are integral.

7. A calculator having a side edge and another adjacent edge and comprising:
one set of apertures disposed on a side edge of the calculator; and
another set of apertures disposed on the adjacent edge of the calculator.

8. A calculator as in claim 7 wherein said edges are perpendicular to each other and said apertures on said side edge are in a different orientation than the orientation of apertures on the adjacent edge.

9. A calculator as in claim 8 wherein said apertures on said side edge have a configuration which accepts rings of different binders, the different binders having at least two different ring orientations.
